(19) United States
(12) Patent Application Publication
(10) Pub. No.: US 2024/0403465 A1
(43) Pub. Date: Dec. 5, 2024

(54) SYSTEMS AND METHODS FOR PROVIDING SECURITY LEVEL BASED GEOSPATIAL NOTIFICATION

(71) Applicant: Palantir Technologies Inc., Denver, CO (US)

(72) Inventors: Daniel Zangri, Austin, TX (US); Nicholas Morgan, Salt Lake City, UT (US); Joshua Dufault, Alexandria, VA (US); Matthew Meacham, Washington, DC (US)

(21) Appl. No.: 18/674,095

(22) Filed: May 24, 2024

Related U.S. Application Data
(60) Provisional application No. 63/555,729, filed on Feb. 20, 2024.
(60) Provisional application No. 63/469,937, filed on May 31, 2023.

(51) Int. Cl. G06F 21/62

(52) U.S. Cl. CPC G06F 21/6218

(57) ABSTRACT

Systems and methods for generating, managing, and/or providing notifications are provided. In some embodiments, a method includes displaying a map corresponding to a map security level to a user, receiving an indication of a geospatial area on the map, receiving a data stream, the data stream corresponds to a data security level, determining if the data security level satisfies a first security level threshold, in response to determining that the data security level satisfies the first security level threshold, in response to detecting the entity that satisfies the notification condition, generating a geospatial notification including information representing the geospatial area and the entity, determining if a user security level for the user satisfies a second security level threshold, and in response to determining that the user security level satisfies the second security level threshold, presenting the geospatial notification to the user.

### CROSS REFERENCE TO RELATED APPLICATIONS

This application claims priority to U.S. Provisional Application No. 63/555,729, filed Feb. 20, 2024, and U.S. Provisional Application No. 63/469,937, filed May 31, 2023, each of which is incorporated by reference herein for all purposes.

### TECHNICAL FIELD

Certain embodiments of the present disclosure are directed to notification systems. More particularly, some embodiments of the present disclosure provide systems and methods for generating, providing, and/or managing geospatial related notifications.

### BACKGROUND

Large streams of data are captured to generate a map that provides representation of an area. Data streams may be further monitored and analyzed to provide notifications to users. However, some data streams may include sensitive information that not all users have access to. In some examples, it is challenging to provide a notification with an appropriate amount of information for a particular user based on a notification condition.

Hence it is highly desirable to improve the techniques for generating, providing and/or managing notifications.

### SUMMARY

Certain embodiments of the present disclosure are directed to notification systems. More particularly, some embodiments of the present disclosure provide systems and methods for generating, providing, and/or managing geospatial notifications.

According to some embodiments, a method for providing a security level based geospatial notification includes displaying a map to a user, the map corresponding to a map security level, receiving an indication of a geospatial area on the map, the geospatial area corresponding to an area security level, receiving a data stream, the data stream corresponds to a data security level, determining if the data security level satisfies a first security level threshold, in response to determining that the data security level satisfies the first security level threshold, detecting whether an entity satisfies a notification condition based on the data stream, in response to detecting the entity that satisfies the notification condition, generating a geospatial notification including information representing the geospatial area and the entity, determining if a user security level for the user satisfies a second security level threshold, and in response to determining that the user security level satisfies the second security level threshold, presenting the geospatial notification to the user. The method is performed using one or more processors.

According to certain embodiments, a computing device for providing a security level based geospatial notification comprises a processor and a memory having a plurality of instructions stored thereon that, when executed by the processor, causes the computing device to display a map to a user, the map corresponding to a map security level, receive an indication of a geospatial area on the map, the geospatial area corresponding to an area security level, receive a data stream, the data stream corresponds to a data security level, determine if the data security level satisfies a first security level threshold, in response to the determination that the data security level satisfies the first security level threshold, detect whether an entity satisfies a notification condition based on the data stream, in response to the detection of the entity that satisfies the notification condition, generate a geospatial notification including information representing the geospatial area and the entity, determine if a user security level for the user satisfies a second security level threshold, and in response to the determination that the user security level satisfies the second security level threshold, present the geospatial notification to the user.

According to certain embodiments, a non-transitory computer-readable medium storing instructions for providing a security level based geospatial notification, the instructions when executed by one or more processors of a computing device, cause the computing device to display a map to a user, the map corresponding to a map security level, receive an indication of a geospatial area on the map, the geospatial area corresponding to an area security level, receive a data stream, the data stream corresponds to a data security level, determine if the data security level satisfies a first security level threshold, in response to the determination that the data security level satisfies the first security level threshold, detect whether an entity satisfies a notification condition based on the data stream, in response to the detection of the entity that satisfies the notification condition, generate a geospatial notification including information representing the geospatial area and the entity, determine if a user security level for the user satisfies a second security level threshold, and in response to the determination that the user security level satisfies the second security level threshold, present the geospatial notification to the user.

Depending upon embodiment, one or more benefits may be achieved. These benefits and various additional objects, features and advantages of the present disclosure can be fully appreciated with reference to the detailed description and accompanying drawings that follow.

### BRIEF DESCRIPTION OF THE DRAWINGS

FIG. 1 is a simplified diagram showing a system for streaming, storing, and processing real-time data according to certain embodiments of the present disclosure.

FIG. 2 is a simplified diagram showing a computing system for implementing one or more components or all components of the system for streaming, storing, and processing real-time data in accordance with at least one example set forth in the disclosure.

FIG. 3 illustrates an example diagram for entities according to some embodiments of the present disclosure.

FIG. 4 is a simplified diagram showing an example of a geospatial notification manager according to one embodiment of the present disclosure.

FIG. 5 is a simplified diagram showing a method for providing a security level-based geospatial notification to a user according to one embodiment of the present disclosure.

FIG. 6 is a simplified diagram showing an exemplary screenshot of a display screen for displaying a geospatial notification on a map according to one embodiment of the present disclosure.

FIG. 7 is a simplified diagram showing an exemplary screenshot of a display screen for displaying a geospatial notification on a map according to one embodiment of the present disclosure.

### DETAILED DESCRIPTION

Large streams of data are captured to generate a map that provides representation of an area. Data streams may be further monitored and analyzed to provide notifications to users. However, some data streams may include sensitive information that not all users have access to. In some examples, it is challenging to provide a notification with an appropriate amount of information for a particular user based on a notification condition.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein. The use of numerical ranges by endpoints includes all numbers within that range (e.g., 1 to 5 includes 1, 1.5, 2, 2.75, 3, 3.80, 4, and 5) and any range within that range.

Although illustrative methods may be represented by one or more drawings (e.g., flow diagrams, communication flows, etc.), the drawings should not be interpreted as implying any requirement of, or particular order among or between, various steps disclosed herein. However, some embodiments may require certain steps and/or certain orders between certain steps, as may be explicitly described herein and/or as may be understood from the nature of the steps themselves (e.g., the performance of some steps may depend on the outcome of a previous step). Additionally, a “set,” “subset,” or “group” of items (e.g., inputs, algorithms, data values, etc.) may include one or more items and, similarly, a subset or subgroup of items may include one or more items. A “plurality” means more than one.

As used herein, the term “based on” is not meant to be restrictive, but rather indicates that a determination, identification, prediction, calculation, and/or the like, is performed by using, at least, the term following “based on” as an input. For example, predicting an outcome based on a particular piece of information may additionally, or alternatively, base the same determination on another piece of information. As used herein, the term “receive” or “receiving” means obtaining from a data repository (e.g., database), from another system or service, from another software, or from another software component in a same software. In certain embodiments, the term “access” or “accessing” means retrieving data or information, and/or generating data or information.

In certain embodiments, as high-scale, real-time data become increasingly common and vital to certain user workflows, analytical features that display and process that data have become important parts of users' tools. As an example, in operational use-cases, live location and signals data usually are the bread-and-butter of creating a trustworthy and seamless shared understanding of an area, which ultimately, for example, allows users to quickly and safely react to complex situations.

In some embodiments, a system (e.g., a backend system) for streaming, storing, and processing real-time data is provided. For example, the system (e.g., the backend system) for streaming, storing, and processing real-time data is built using one or more storage layers, one or more computation layers, and/or one or more query layers to serve as a fast and/or horizontally-scalable solution for different shapes and/or sizes of real-time data.

According to certain embodiments, the system may use one or more computing models to process the high-scale, real-time data (e.g., real-time geospatial data). In certain embodiments, a computing model, also referred to as a model, includes a model to process data. In certain embodiments, a model includes, for example, an AI model, a machine learning (ML) model, a deep learning (DL) model, an image processing model, an algorithm, a rule, other computing models, a large language model (LLM), and/or a combination thereof.

According to certain embodiments, a language model is a computing model that can predict the probability of a series of words, for example, based on the text corpus on which it is trained. In some embodiments, a language model can infer word probabilities from context. In some embodiments, a language model can generate word combinations (and/or sentences) that are coherent and contextually relevant. In certain embodiments, a language model can use a computing model that has been trained to process, understand, generate, and manipulate language. In some embodiments, a language model can be useful for natural language processing, including receiving natural language prompts and providing natural language responses, speech recognition, natural language understandings, and/or the like. In certain embodiments, a language model includes an n-gram, exponential, positional, neural network, and/or other type of model.

According to some embodiments, a large language model (“LLM”) is a type of language model that has been trained on a larger data set and has a larger number of parameters (e.g., billions of parameters) compared to a regular language model. In certain embodiments, an LLM can understand more complex textual inputs and generate more coherent responses due to its extensive training. In certain embodiments, an LLM can use a transformer architecture that is a deep learning architecture using an attention mechanism (e.g., which inputs deserve more attention than others in certain cases). In some embodiments, a language model includes an autoregressive language model, such as a Generative Pre-trained Transformer 3 (GPT-3) model, a GPT 3.5-turbo model, a Claude model, a command-xlang model, a bidirectional encoder representations from transformers (BERT) model, a pathways language model (PaLM) 2, and/or the like.

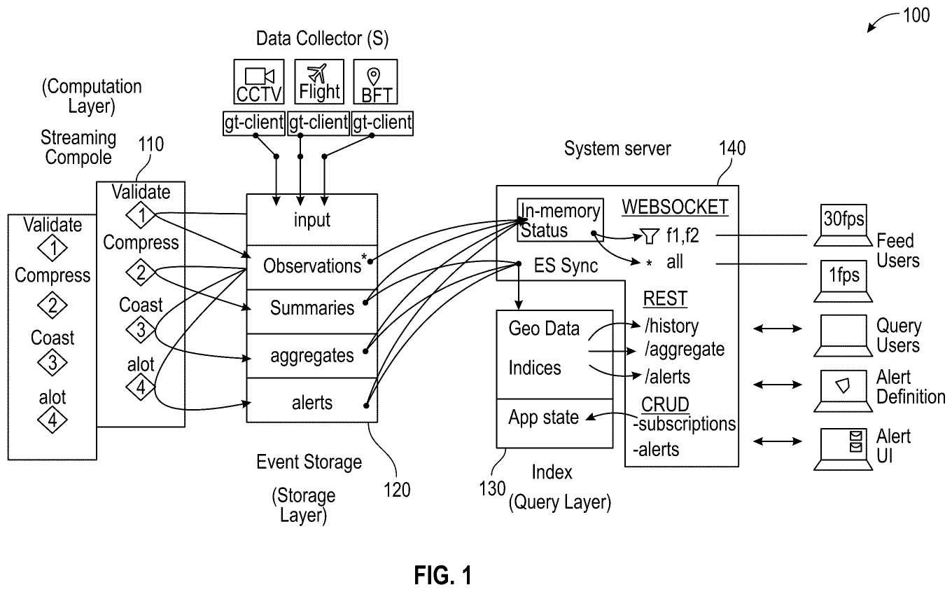

FIG. 1 is a simplified diagram showing a system for streaming, storing, and processing real-time data according to certain embodiments of the present disclosure. This diagram is merely an example. One of ordinary skill in the art would recognize many variations, alternatives, and modifications. For example, the system 100 for streaming, storing, and processing real-time data includes a computation layer 110, a storage layer 120, a query layer 130, and a system server 140. Although the above has been shown using a selected group of components for the system for streaming, storing, and processing real- time data, there can be many alternatives, modifications, and variations. For example, some of the components may be expanded and/or combined. Other components may be inserted to those noted above. Depending upon the embodiment, the arrangement of components may be interchanged with others replaced. Further details of these components are found throughout the present disclosure.

In some examples, the system 100 (e.g., a backend system) for streaming, storing, and processing real-time data is configured to perform one or more or all of the following tasks:
1. Provide a low-latency system for streaming real-time location data according to certain embodiments.
2. Provide a system for querying and/or aggregating historical location data collected for longer-term storage (e.g., with one or more retention controls) according to some embodiments.
3. Provide real-time geofence alerting for data entering the system that meet one more configurable queries according to certain embodiments.
4. Act as a source by which geotemporal series can be referenced from one or more certain objects according to some embodiments.
5. Provide one or more APIs for bulk uploading data to the system's history store according to certain embodiments.

In certain examples, the system 100 (e.g., a backend system) for streaming, storing, and processing real-time data provides two broad paths for data entering the system:
1. Fast path: data entering the system are written to the storage layer 120 according to some embodiments. For example, the computation layer 110 performs basic validation. As an example, the system server 140 sends the data out over any active, relevant data subscription.
2. Slow path: after passing through the fast path, the computation layer 110 performs one or more processing jobs on the data for one or more or all of the following tasks according to certain embodiments:
   a) Data summarization: before the data are stored in the query layer 130 for querying, data are deduplicated by one or more configurable levels of time and distance (e.g., users of the system 100 can determine that for a data type, they wish to only save a single point for a time period of Y length if the entity has moved less than X meters) according to some embodiments.
   b) Alerts: perform real-time alerting, such as when an entity enters and/or exits a user-defined region, according to certain embodiments.
   c) Aggregations: bucketing data by one or more time windows and/or filters to see one or more aggregate views (e.g., one or more histograms) of data flowing through the system 100 according to some embodiments.

In some examples, data entering the system 100 (e.g., a backend system) for streaming, storing, and processing real-time data includes the fields for series identification, entity identification, entity type, position, and timestamp (e.g., date and time). For example, one or more live data subscriptions, one or more history queries, and/or one or more alerts are represented as one or more queries over any of these fields. As an example, the data entering the system 100 (e.g., a backend system) contain one or more extra extension properties as additional metadata.

According to some embodiments, the system 100 (e.g., a backend system) for streaming, storing, and processing real-time data includes a separate integration service for basic real-time and/or bulk upload integrations. For example, the system 100 (e.g., a backend system) also provides a Java client for streaming data to the storage layer 120.

According to certain embodiments, the system 100 (e.g., a backend system) for streaming, storing, and processing real-time data provides a subscription API, a path history API, and an aggregation API. For example, the system 100 (e.g., a backend system) provides basic bulk upload functionality and/or real-time alerting.

According to some embodiments, data from the system 100 (e.g., a backend system) are viewed in one or more or all of the following ways:
a) Live layers
b) Track search
c) User-requested aggregations
d) AI aggregations
e) Real-time alerting
Track data linked to certain objects

Certain embodiments of the present disclosure include systems and methods for streaming geotemporal data. In some embodiments, stream processing is a fundamentally different paradigm from batch processes for two major reasons: 1) a stream of data can be arbitrarily large (e.g., for practical purposes, infinite); and 2) streams are often time-sensitive and made available to users in real-time. In some embodiments, time becomes a crucial aspect of streaming data. In certain embodiments, large amounts of data (e.g., infinite data) may not be practically stored. For example, a geotemporal data staging stack ingests greater than 40 GB of data every hour. In some examples, while data storage is cheap, at that rate, at most on-premises deployments, storage may be used up in days, if not hours.

In some embodiments, infinite data means the system processing the data cannot wait until all the data is available, then run a batch job. In certain embodiments, time sensitivity means the system can barely wait at all before processing data. For example, some systems demand sub-second (e.g., less than 1 second) latency. In certain embodiments, stream processing platforms have one or more of three parts: 1) an unbounded queue to accept writes from source systems; 2) a streaming data analysis framework that processes records from the queue; and 3) a traditional data store where analysis results get written.

According to certain embodiments, the system 100 includes features of tracking entities (e.g., objects, planes, ships, etc.) through time and space to support analytic workflows. For example, the analytic workflows include: showing where this ship has gone this year; and/or listing the planes that landed at this airport this month. In some embodiments, the system can receive streaming geotemporal data with sub-second latencies.

According to some embodiments, an observation refers to a location of an entity at a moment in time. In some embodiments, an entity refers to an object, a person, a moving object, a building, a static object, and/or the like. In some embodiments, a track refers to a time series of observations. In certain embodiments, a lifecycle of an observation includes an input process, a validation process, and/or an analysis process. In some embodiments, the system includes one or more interactive parts for an observation. For example, the system includes an interface to allow receiving (e.g., writing) an observation (e.g., by a data source system), a communication channel (e.g., a websocket endpoint) that continually serves the latest observations, and/or a software interface (e.g., Conjure API) for building heatmaps, querying an entity's movements, and/or the like.

In some examples, a data structure for an observation includes a seriesType, seriesId and entityId. In certain examples, the seriesId is the unique identifier for the track that contains the observation (e.g., seriesId might be “A-airline997-november-8”). In some examples, the entityId is the unique identifier of an entity (e.g., “A-enterprise”) and the field can be used to query over the full set of tracks for the ones relevant to a specific entity. In certain examples, the series Type corresponds to the data source, for example, a ship tracking service.

In certain embodiments, the observation's lifecycle begins with a push from a client source system. For example, a client system writes the observation to a proxy. As an example, the proxy forwards the observation to the tracking service. In some embodiments, the observation is serialized (e.g., Avro binary). In certain embodiments, a validator job loads the observation, determines whether the observation is valid, and sends the observation (e.g., the serialized observation) to the tracking service based on whether the observation is valid or not. In some embodiments, if the observation is invalid, the observation is sent to a component for error inputs, for example, to determine why the observation is invalid. In certain embodiments, if the observation is valid, the observation is submitted for search indexing operations and/or for communication operations via communication channels (e.g., websockets, websocket APIs (application programming interface), duplex communication channels). In some embodiments, both search indexing and communication operations should be low-latency. In some embodiments, the communication operations have sub-second latencies, whereas search indexing operations can be an order of magnitude slower.

According to some embodiments, the search indexing operations include, for example, reading the valid observation, writing the newest observation for the entity to a search engine periodically (e.g., downsampling, less frequent than the frequency of receiving the observations), serving the observation's track and individual points to search clients by the search engine, and/or the like. In certain embodiments, the system loads the valid observation and checks if any clients have subscribed to updates about the observation (e.g., 22nd fleet). In some embodiments, for each client interested in the observation, the system 100 enqueues the observation. In certain embodiments, after applying some checks and/or analysis (e.g., Is bandwidth available? Does the client already have newer data?), the observation is sent to a client.

According to certain embodiments, the system 100 can be deployed in one or more remote environments (e.g., cloud environments) and/or one or more on-premises environments. In some embodiments, the system 100 can be deployed with single nodes for small form factor on-premises stacks.

According to some embodiments, an observation refers to an event at a single time and place (e.g., a GPS (global position system) ping). In certain embodiments, a track refers to a time series of observations from the same source (e.g., the history of places that a shark wearing a GPS tag has been). In some examples, observations are schematized according to observation specifications. For example, the observation has the following data structure:
sourceSystemId #ID (identifier) of the source system where the data came from, defined when setting up an integration
collectionId #ID for the collection within a source system, defined when setting up an integration
observationSpecId #ID for this Observation schema
gid #global ID for the track, created automatically when data is integrated
seriesId #an integrator-defined stable ID that refers to a track over time
position #the location of the Observation
timestamp #when the observation took place
expirationTimestamp #calculated automatically from timestamp+TTL (time-to-live): the timestamp at which the observation is no longer considered “live” or active
style #styling information to be used by the front-end
optional<entityId> #user-defined ID that refers to the entity represented by the observation (resolvable across tracks)
optional<ttl> #if present, the observation uses this value for TTL: if absent, the observation uses TTL set in the integration config
acl #the ACL (access control list) for a track
set<liveFields> #configurable data in the system that varies over time; see below for a description
set<staticFields> #configurable data in the system that does not over time: see below for a description

According to some embodiments, a field in the system is a key-value pair of a name and a typed value. For example, an entity's speed may have field name “speed” and field value of type double. In certain embodiments, a “live field” (e.g., liveFields) is expected to update with each observation in a track. Examples may include speed or heading. In some embodiments, for each timestamp on a track, the system stores the value of that live field. In certain embodiments, a “static field” is not expected to update with each observation in a track. Examples may include a plane's tail number or a ship's callsign. In some embodiments, the system stores the most recent value of a static property. In certain embodiments, the choice of live and static fields, along with their names and types, is configurable in an observation specification.

According to certain embodiments, each field in an observation can be configured with a certain trait (e.g., configuration), indicating how frontends should display the field. In some embodiments, there are three or more types of field traits:
FEATURED: This field is prioritized in displays and search fields. This trait does not affect the backend data store or queries to the system.
DEPRECATED: This field is deprecated, and as such is hidden from displays and search fields. This trait does NOT affect the backend data store or queries to the system.
HIDDEN_FROM_HISTOGRAM: This field is not included in histogram queries. For example, recommended for fields with a large number of unique values, which do not result in useful histograms.

According to some embodiments, a track is identified by a GID (e.g., global ID). For example, a GID includes geotemporal-track.<sourceSystemId>.<collectionId>.<observationSpecId>.<seriesId>. In certain embodiments, the GID does not include entityId. In some examples, this is different compared to traditional integrations, where tracks were identified by the unique (seriesId, entity Id) pair.

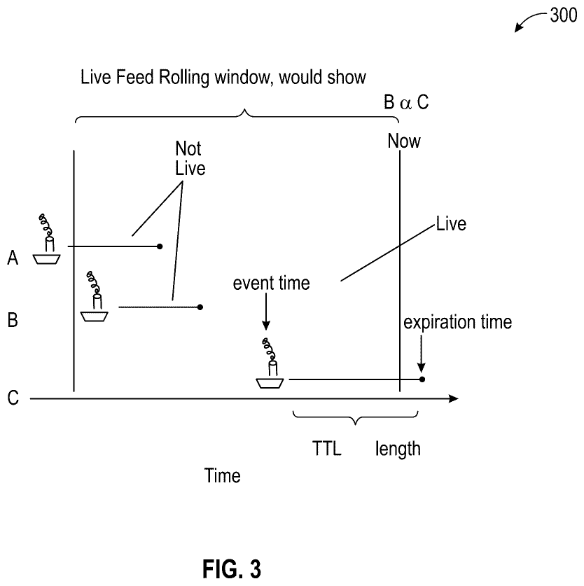

According to certain embodiments, liveness is a special property that is a combination of: when an observation took place (event time); and/or a time-to-live (TTL) time set by the data integrator. FIG. 3 illustrates an example diagram 300 for entities A, B, and C. In the example illustrated in FIG. 3, at current time “now”, only ship C is considered Live, per its event time and the assigned expiration time on integration.

In some embodiments, the system can define a window of time for entities that will continue to update in the future. In certain embodiments, the window of time (e.g., rolling window length) means that the layer will include any data that was live in the past. In some embodiments, this is done via a range query on the expirationTimestamp field for the latest observation in a track.

According to certain embodiments, referring back to FIG. 1, data is integrated into the system 100 via a record extractor, which transforms source data into a desired data format that is then formatted into observations to be streamed to the system 100. In some embodiments, record extractor plugins run within a service (e.g., a geotemporal integration engine (GIE)). In certain embodiments, the GIE supports existing plugins. In some embodiments, the GIE also supports running plugins that are shipped as assets that are packaged from code that lives in exclusive or air-gapped environments. In certain embodiments, the system 100 and/or the GIE supports one or more plugins dynamically loaded and run by a GIE service.

According to some embodiments, the system 100 includes querying integrations. In certain embodiments, once data (e.g., geotemporal data) is received, stored, and/or processed in the system 100, at least two mechanisms through which data can be retrieved via one or more communication layers. In some embodiments, the one or more communication layers include one or more non-vectorized layers (e.g., duplex communication channels, websockets) and one or more vectorized layers.

According to certain embodiments, the one or more non-vectorized layers stream every observation coming from the integration to the client and aim to have low latency (e.g., sub-second latency). In some embodiments, the system 100 should use the one or more non-vectorized layers when the data source has low-cardinality (e.g., 10-100 unique tracks), fast-updating data where smooth updates to data (e.g., updates on a map) are important (e.g., assets flying). In certain embodiments, the system 100 should avoid using non-vectorized layers for high-cardinality or slowly-updating integrations (i.e. BAS (broad area search)). In some embodiments, the non-vectorized layers allow data to flow through the system 100 at the lowest possible latency.

According to some embodiments, the one or more vectorized layers, also referred to as vector tiles, query a snapshot of the most recent observation and encode them in a vectorized format for a compact data representation. In certain embodiments, the one or more vectorized layers can support layers containing a large number of observations (e.g., millions of observations) and should be used with high-cardinality and/or slowly-updating integrations (e.g., BAS, AIS (automated identification system)). In some embodiments, the system 100 should avoid vector tiles when streaming updates to data (e.g., updates to map) is important (e.g., ISR (intelligence, surveillance and reconnaissance)), since vector tiles update slowly. For example, vector tiles may update every 4 seconds at quickest, and every 10 minutes at slowest. In certain embodiments, vector tiles are supported by queries to a search engine (e.g., Elasticsearch). In some examples, data is written into the search engine after applying a down sampling window (e.g., every 30 seconds), and tracks encoded in vector tiles can update at the sampling frequency (e.g., once every 30 seconds) or at a maximum frequency of the sampling frequency.

According to certain embodiments, the system 100 may be exposed to client systems via one or more live layers, which may include, for example, subscriptions, feeds, or enterprise map layers (EMLs), and/or the like. In some embodiments, these can be configured in an administrative application. In certain embodiments, only feeds with data that the user has access to will show up. In some embodiments, one or more feeds can contain multiple observation specifications within them. In some embodiments, if a feed includes observations A and B that matches integrations A and B, but the user only has access to A, the user will still see the feed, but it will only contain data from integration A. In certain embodiments, one or more feeds are always filtered to only contain data the user can see, even if the feed's query itself matches more data. In some embodiments, the system 100 refreshes the list of feeds periodically and/or by a trigger. For example, the system 100 refreshes the list of feeds from the administrative application every minute.

According to some embodiments, the system 100 queries a search engine (e.g., Elasticsearch). In certain embodiments, for every geo-temporal-backed data integration, the system 100 creates multiple search indices (e.g., Elasticsearch indices) to store the data in. For example, one stack can have hundreds, sometimes thousands, of indices. In some embodiments, to query the search engine, the system 100 specifies which indices the search engine should look at for the requested data. In certain embodiments, this can make queries more efficient, and it also addresses the fact that different indices may have different fields. For example, a BAS index and an ISR index have very different schemas.

According to certain embodiments, when the system 100 receives a query, it analyzes the query and determines which observation specifications could match the query. For example, the system may use heuristics like “Does this specification have the fields requested?” or “Does the query mention a particular observation specification?”. In some embodiments, the system 100 may select and/or expand the matching observation specifications into the search indices to search.

According to some embodiments, the system 100 can provide one or more alerts on geotemporal data. In certain embodiments, a geotemporal alert is a query on geotemporal data that notifies users as soon as the query becomes true (e.g., when the alert “fires”). In some embodiments, geotemporal alerting workflows are managed on a configuration user interface (UI). For example, users can configure the alert's backing query (e.g., “alert when AIS data enters the Mediterranean Sea”). As an example, users can configure the query by clicking on a map to represent a geofenced region like the Mediterranean Sea (or any arbitrary shape). In this example, in the same UI, users can configure the alert's notifications. In certain embodiments, this attains low latency by running queries on geotemporal data upstream of the search engine, for example, in a processing job.

According to certain embodiments, the system 100 may include one or more types of alerts. In some embodiments, one type of alert is an entity state change alert, which is a type of alert indicating if geotemporal tracks flip from matching the alert query (or a list of queries, which are OR-ed with each other) to not matching, or vice versa. For example, “Fire an alert if AIS track with series ID F leaves the Mediterranean Sea.”

In certain embodiments, one type of alert is a count timestamp alert, which is a type of alert indicating if the number of observations matching the alert query meets a configurable threshold during a fixed time interval. For example, “Fire an alert if more than 10,000 AIS observations enter the Mediterranean Sea between 10:00Z and 12:00Z.”

In some embodiments, one type of alert is a multi-linked entity distance alert, which is a type of alert indicating if all query conditions are satisfied by a set of observations within a given distance of another observation (as defined by another observation query). For example, “Fire an alert if AIS track with series ID F and an ELINT track with series ID A111 both come within 500 meters of AIS track with series ID B.”

In certain embodiments, one type of alert is a linked entity distance alert, which is a special case of multi-linked entity distance alerts, but only supporting one type of track. For example: “Fire an alert if AIS track with series ID F comes within 500 meters of AIS track with series ID B.”

In some embodiments, one type of alert is a multi-threshold alert, which is a type of alert indicating if the number of observations (possibly of multiple types) matching the alert query meets a configurable threshold over a sliding time window. This is not to be confused with a count timestamp alert, which is over a fixed time interval. For example: “Fire an alert if more than 10,000 AIS observations and more than 1,000 ELINT observations enter the Mediterranean Sea in any 60-minute sliding time window.”

In certain embodiments, one type of alert is a threshold alert, which is a special case of multi-threshold alerts, but only supporting one type of track. For example: “Fire an alert if more than 10,000 AIS observations enter the Mediterranean Sea in any 60-minute sliding time window.”

According to some embodiments, the system 100 allows administering integrations. In certain embodiments, integrations are administered from their corresponding source system specification. For example, one or more of the following features of integration can be configured:
Retention (retentionDays): the amount of time for which to retain data from an integration
Index Rollover Period for the search engine (rolloverDays): the period of time you keep per historical index
Time-to-Live (ttlMillis): the defined time by which an integrated observation from this integration is considered “active” or “live”, if the observation itself does not specify a TTL
Dedupe Parameters (dedupeTicks): the parameters used to decide if two data successive data points from integration are the same (or close enough where it's only needed to save one, which is useful for integrations that send many data points per second)
Aggregation View Preferences (aggregationView): a Boolean to say if feeds that include data from this integration should be displayed as aggregation bubbles (see screenshot in the extra information section below)
ACL (acl): a security level that can be set at the collection or source system level. This sets the required classification and group membership needed to access data from an integration. In certain cases, the system allows for ACLs to be set on the individual track.
Monitors (monitors): configuration for monitors to alert on configured criteria.

In some embodiments, data from each source system is divided into collections, which are integrator-defined subsets of data in a source system (e.g., classified buckets of data and unclassified buckets of data from the same source, or different types of data from the same source). In certain embodiments, within each collection, an optional configuration can be specified per observation specification expected in the integration with one or more of the above settings.

In certain examples, retentionDays specifies for how many days data will be kept from a given integration. By default, in some examples, this is set to the global, service-level retention length. In some examples, retentionDays set at the integration-level may supersede the service-level setting. In certain examples, retention is based on the time data is integrated, not the timestamp on the data itself.

In some examples, dedupe parameters (e.g., dedupeTicks) are used to reduce the amount of fast-updating, high-volume data saved when a source is sending more data than is analytically valuable for historical analysis. In certain examples, dedupe only happens on successive Observations within the same track, for example, the path of a single plane within an integration, and only affects how much data is saved for history—it does not affect how much data is sent to subscriptions (e.g., websocket-based subscriptions).

In certain examples, ACLs can be set on the Source system or on a collection to describe the security level of data within that Source system or collection. In some examples, when ACL: is set, only users who meet the group and classification criteria will be able to see data from the source system or collection. In certain examples, a user must be working within an Investigation or map (or other artifacts) that has its authorization set at or above the ACL of data from the associated source system that they want to see.

In some examples, monitors can be created on the collection level. In certain examples, the system 100 treats a source system specification level monitor as equivalent to setting the monitor on every collection.

According to some embodiments, the system 100 includes one or more security modes. In certain embodiments, the system 100 supports two security models (e.g., modes), which are separate and mutually exclusive: the integration security model (e.g., integration security mode) and the track-level security (TLS) model (e.g., TLS mode). In some embodiments, the integration security model is accessible and can support a significantly higher scale of data. In certain embodiments, in this security model, each observation is secured based on the security of its collection (if available) or the security of its source system specification as a fallback.

In some embodiments, the track-level security model puts a separate ACL (access control list) on every track and allows for significantly greater granularity. In certain embodiments, however, this makes the processing in this security mode slower. In some embodiments, the system 100 implements the security approach at each step of an observation's lifecycle, for example, being indexed, being searched, triggering an alert, and being live-rendered.

According to certain embodiments, the system 100 implements security at index time. In some embodiments, using the integration security model, when an observation is sent to the system, it already contains security-related information. In some examples, using this model, the security of an observation is specified by the (Source System Spec ID, Collection ID) tuple it carries. In certain embodiments, using TLS model, the system 100 the observation to carry a configuration (e.g., AclConfig) specifying its security. In some embodiments, if an observation does not carry a configuration in the TLS mode, it is considered globally visible. In certain embodiments, a search engine may use a TLS model.

According to certain embodiments, the system 100 implements security at search time. In some embodiments, the system 100 implements security at alert time. Using the integration security model, in certain embodiments, the system 100 secures an alert criterion based on the intersection of specifications that the subscribers can access. Using TLS model, in some embodiments, the system 100 creates a proxy token for each subscriber, gets the accessible ACL IDs for each of them, and sets the intersection as the security for the alert criterion.

According to some embodiments, the system 100 implements security at render time. In certain embodiments, feeds are secured on creation time. In some embodiments, feeds are secured either based on a set of integrations or a set of ACL IDs.

According to certain embodiments, the system 100 may implement two or more options for security, for example, configuration-based (e.g., ACLs, groups, classification, etc.) security, and resource-delegating security. In some embodiments, the configuration-based security is specified in the configuration in the source system specification. In certain embodiments, the configuration-based security may follow one or more standard security specifications. In some embodiments, the system 100 specifies security based on the classification. In certain embodiments, the system 100 uses the security of data to avoid maintaining the same data with different securities. In some embodiments, the system 100 may include one or more mandatory nodes used to enforce mandatory requirements and/or one or more discretionary nodes used to enforce group-based security.

According to some embodiments, for the resource-delegating security model, downstream datasets inherit mandatory requirements (e.g., classifications, markings) from upstream data and/or downstream datasets do not inherit discretionary requirements (e.g., read permissions, view permissions). In some embodiments, the system 100 can receive specified security at either the collection level or the source-system level. In certain embodiments, if a collection lacks security specification, the security is inherited from the source system; that is, when present, the collection security takes precedence over source system security.

According to certain embodiments, the system 100 can purge old data on a configurable schedule. In some embodiments, the system 100 can purge old data based on the storage system. In certain embodiments, the system 100 can purge old data by deletion by query. In some embodiments, the system 100 can log events of creating, modifying, and/or loading geotemporal data. In certain embodiments, certain high-volume logging events are excluded by default and may be enabled in configuration if desired. In some embodiments, logging is done using one or more system endpoints (e.g., proxy) of the system 100.

According to some embodiments, the system 100 allows streaming and/or batch ingestion. In certain embodiments, the system 100 supports two pathways to ingest data: the streaming pipeline and the batch pipeline. In some embodiments, both mechanisms will make data searchable and considered for alerting, but may have different purposes for different workloads. In some embodiments, the majority of geotemporal data flows through the streaming pipeline.

According to certain embodiments, the streaming pipeline uses all streaming architecture (e.g., Apache Kafka, Apache Flink), enabling fire-and-forget and low-latency ingest of data. For example, data enters this pipeline through a proxy or an endpoint which clients can sink to via the provided client system. In some embodiments, the streaming pipeline is suited for data with at least one of the following characteristics: high-scale, low-latency, and continuous. For example, ISR data points stream in at 30 or more points a second and are streamed continuously through non-vectorized layers (e.g., websockets) to the front-end so users can see the plane moving in near real-time.

In certain embodiments, due to the nature of streaming data, the system 100 may not store every point that comes in through the streaming pipeline: instead, the track can be downsampled such that the system 100 does not lose the fidelity of the track. In some embodiments, the system 100 may ignore a point if it's within a threshold time (e.g., 10 seconds) in event time and/or within a threshold distance (e.g., 5 km) of the previous point. In some embodiments, the threshold time and/or the threshold distance can be configured per integration. In certain embodiments, the system 100 may only update the most-recent observation in a track at a pre-determined frequency (e.g., every 30 seconds of processing time). In some embodiments, the predetermined frequency is not configurable.

According to some embodiments, the batch pipeline synchronously sinks data to the system 100 making it slower than the asynchronous and distributed streaming pipeline. In certain embodiments, one or more client systems can sink data using the geotemporal-indexer service. In some embodiments, the batch pipeline is suited for data with at least one of the following characteristics: one-time imports of data, data that comes in batches, data where downsampling points are unacceptable, data that requires immediate notice of invalidity (e.g., streaming will sink invalid data to a dead letter queue, while the batch pipeline will return the errant data). For example, BAS data comes in batches when a satellite image has been processed and doesn't require low latency delivery of messages, and thus uses the batch pipeline. In some embodiments, since data through the batch pipeline doesn't come in continuously, the batch pipeline does not support real-time streaming of data to the front-end through one or more non-vectorized layers (e.g., websockets); however, it still supports rendering through one or more vectorized means.

As shown in FIG. 1, the system 100 for streaming, storing, and processing real-time data implements a system and method for user interface with manual geospatial correlation according to certain embodiments. In some examples, the system and method for user interface with manual geospatial correlation allows a user to see location data on a map and then manually associate the location data with an entity (e.g., a ship) and represent the entity's location accordingly. In other examples, the system and method for user interface with manual geospatial correlation provide a user interface that allows a user to start with location data and then link the location data to an entity that may or may not be on the map. For example, a sensor is outputting location data of Entity A from Source X, but the location data from Source X are not associated with an existing ID that has already been associated with location data about the same Entity A from Source Z. As an example, the user interface with manual geospatial correlation allows a user to manually correlate the location data from Source X with the existing ID that has already been associated with location data about the same Entity A from Source Z, and then to automatically update Entity A with the location data from Source X.

According to some embodiments, one or more users use at least one or more user interfaces with manual geospatial correlation to integrate and/or use geotemporal data in one or more workflows of the one or more users. For example, in certain operational contexts, location data is the foundation for building situational awareness around the world. As an example, being able to model the location data, secure the location data, see the location data, and/or combine the location data with one or more other data sources is important to at least some users' workflows.

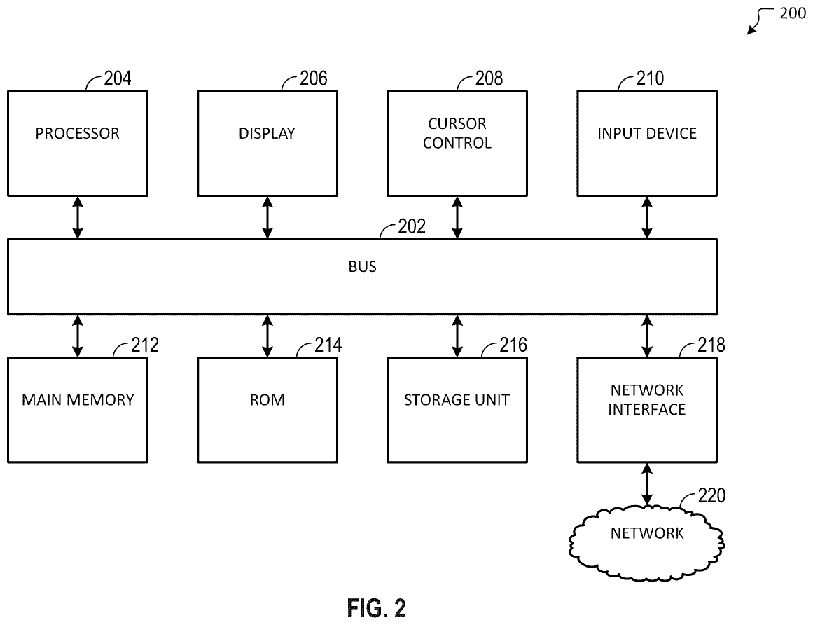

FIG. 2 is a simplified diagram showing a computing system for implementing one or more components or all components of the system 100 for streaming, storing, and processing real-time data in accordance with at least one example set forth in the disclosure. This diagram is merely an example. One of ordinary skill in the art would recognize many variations, alternatives, and modifications.

The computing system 200 includes a bus 202 or other communication mechanism for communicating information, a processor 204, a display 206, a cursor control component 208, an input device 210, a main memory 212, a read only memory (ROM) 214, a storage unit 216, and a network interface 218. In some examples, the bus 202 is coupled to the processor 204, the display 206, the cursor control component 208, the input device 210, the main memory 212, the read only memory (ROM) 214, the storage unit 216, and/or the network interface 218. In certain examples, the network interface 218 is coupled to a network 220. For example, the processor 204 includes one or more general purpose microprocessors. In some examples, the main memory 212 (e.g., random access memory (RAM), cache and/or other dynamic storage devices) is configured to store information and instructions to be executed by the processor 204. In certain examples, the main memory 212 is configured to store temporary variables or other intermediate information during execution of instructions to be executed by processor 204. For examples, the instructions, when stored in the storage unit 216 accessible to processor 204, render the computing system 200 into a special-purpose machine that is customized to perform the operations specified in the instructions. In some examples, the ROM 214 is configured to store static information and instructions for the processor 204. In certain examples, the storage unit 216 (e.g., a magnetic disk, optical disk, or flash drive) is configured to store information and instructions.

In some embodiments, the display 206 (e.g., a cathode ray tube (CRT), an LCD display, or a touch screen) is configured to display information to a user of the computing system 200. In some examples, the input device 210 (e.g., alphanumeric and other keys) is configured to communicate information and commands to the processor 204. For example, the cursor control component 208 (e.g., a mouse, a trackball, or cursor direction keys) is configured to communicate additional information and commands (e.g., to control cursor movements on the display 206) to the processor 204.

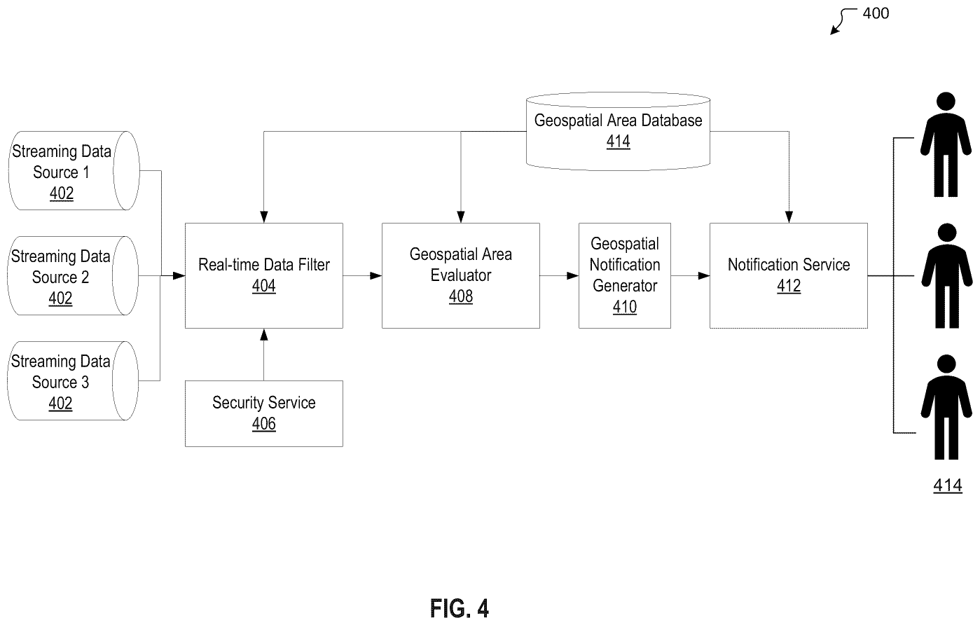

FIG. 4 is a simplified diagram showing a geospatial notification manager that is configured to provide a security level-based geospatial notification to a user according to one embodiment of the present invention. This diagram is merely an example, which should not unduly limit the scope of the claims. One of ordinary skill in the art would recognize many variations, alternatives, and modifications.

To do so, the geospatial notification manager is configured to receive data streams from one or more streaming data sources 402. Upon receiving data streams, the geospatial notification manager filters the incoming data stream in near real-time via a real-time data filter 404. In other words, as the data steam is being received, the incoming data is processed to determine if the data satisfies a security level threshold. According to some embodiments, the data security level of an incoming data stream is predetermined or predefined based on where the incoming data stream is received from. For example, a predefined data security level may be associated with each sensor or each type of sensor that is capable of generating a data stream. As described further below, each data stream corresponds to a data security level to control who can access content of the corresponding data stream. For example, if a user corresponds to a user security level is level 3, the level 3 user is allowed to access data streams with the data security level that is lower than level 3.

The geospatial notification manager is further configured to evaluate a geospatial area that corresponds to an area security level via a geospatial area evaluator 408. According to some embodiments, a user may draw any shape of a polygon on a map to indicate a desired geospatial area that the user is interested in. For example, the user input may be received via an interactive element on a display of the computing system 200. For example, in some embodiments, the interactive element is a button, a drawing tool, or any interface element capable of receiving the user input. It should be appreciated that the selected geospatial area is stored in a geospatial area database 414.

According to certain embodiments, the user may select a desired geospatial area from a list of predefined geospatial areas stored in the geospatial area database 414. For example, as shown in the exemplary display screen 600, the geospatial area is presented by a polygon 604. According to some embodiments, the area security level is equal to a map security level of the map. The area security level of the geospatial area indicates how much information that was received within the geospatial area should be accessible to a user. For example, as described further below, the area security level relates to whether data received from sensors that are detected within the geospatial area should be processed. According to some embodiments, the area security level of the geospatial area is set to the same security level as the map security level of the map as default. However, the user may change the area security level of the geospatial area to be lower than the map security level of the map. For example, if the map security level is level 3, the area security level of the geospatial area may be automatically set to level 3. As described above, the user may change the area security level to be lower than level 3 (e.g., level 1 or 2) but not higher than level 3 .

Additionally, the geospatial notification manager is configured to generate a geospatial notification that corresponds to a notification security level via a geospatial notification generator 410. According to certain embodiments, the geospatial notification includes information representing the geospatial area and a location of the identified entity that satisfied the notification condition within the geospatial area. In some embodiments, the geospatial notification further includes an identity of the entity and the time when the entity satisfied the notification condition. For example, as shown in the exemplary display screen 600, the geospatial notification may be presented with a geospatial area polygon 604 and the location of the identified entities 606 and 608.

According to some embodiments, the geospatial notification manager is configured to generate multiple geospatial notifications based on different thresholds. For example, a first geospatial notification may indicate that the entity is traveling into the geospatial area, a second geospatial notification may indicate that the entity is exiting out of the geospatial area, and/or a third geospatial notification may indicate that one or more entities satisfy a predefined condition. For example, in some embodiments, the thresholds that trigger the geospatial notification manager to generate a geospatial notification include a particular direction of travel or heading of an entity and/or a number of entities detected within a predefined area within a geospatial area. For example, in an example of airplanes, a first geospatial notification may be generated when an airplane is detected within the geospatial area and is heading into the geospatial area. A second geospatial notification may be generated when an airplane is detected within the geospatial area and is heading outside of the geospatial area. A third geospatial notification may be generated when there are more than 3 airplanes within the geospatial area at a given time and/or an airplane with a particular flag is detected within the geospatial area.

According to certain embodiments, the geospatial notification manager is configured to generate a geospatial notification upon detecting an anomaly condition. For example, in some embodiments, an anomaly condition includes an unusual or different direction of travel compared to a usual direction that an entity travels in. In an example of ships, if a ship normally travels in a particular direction (e.g., west) between two locations (e.g., between point A and point B), a geospatial notification is generated when a ship is detected to travel in a different direction (e.g., north).

According to certain embodiments, the geospatial notification manager is configured to utilize machine learning models (e.g., machine learning algorithms, language models, large language model (LLM)) to determine a predefined condition for generating or triggering geospatial notifications that the user may be interested in. In some embodiments, a user can use natural language queries (e.g., conditions and thresholds that trigger a geospatial notification) to request the geospatial notification manager to generate a geospatial notification. According to certain embodiments, training data for training one or more machine learning models includes previous notification requests, previous geospatial notifications, user data (including user levels associated with users), previously defined geospatial areas, map data, and/or previously identified target entities.

To do so, the geospatial notification manager may consider previous notification requests and/or previous geospatial notifications. In certain embodiments, the machine learning models are trained using previous notification requests and/or previous geospatial notifications generated for users to learn, for example, user preferences and conditions and/or thresholds that trigger generation of geospatial notifications. For example, similar user preferences, conditions, and/or thresholds may be suggested based on the user level of a particular user based on user preferences, conditions, and/or thresholds for other users who are in the same user level.

Additionally, according to some embodiments, one or more user preferences, conditions, and/or thresholds are suggested based on a type of a target entity and/or a type of geospatial area. For example, the geospatial notification manager may suggest one or more user preferences, conditions, and/or thresholds based on previous notification requests and/or previous geospatial notifications related to entities that have similar properties (e.g., buildings, vehicles, airplanes, ships, people, moving/immobile, etc.) as the target entity using one or more machine learning models. Additionally or alternatively, the geospatial notification manager may suggest one or more user preferences, conditions, and/or thresholds based on previous notification requests and/or previous geospatial notifications related to geospatial areas that have similar properties (e.g., location, rural, urban, environment, etc.) as the target geospatial area.

For example, a user requests the geospatial notification manager to generate a geospatial notification if an anomaly in travel behaviors (e.g., a route and/or a direction of travel) of a target entity is detected. To do so, in certain embodiments, the geospatial notification manager utilizes one or more machine learning models to determine usual travel behaviors of the target entity and determine whether the target entity is departing from its usual travel behaviors.

According to some embodiments, the notification security level of the geospatial notification is set to the same level as the area security level of the geospatial area. For example, if the area security level of the geospatial area is level 3, the notification security level of the geospatial notification is set to level 3. According to certain embodiments, the content of the geospatial notification may depend on the notification security level of the geospatial notification. Additionally or alternatively, in some embodiments, the content included in the geospatial notification may depend on the user security level of the user. In other words, some users may be entitled to more information related to the detected entity compared to other users based on their user security levels.

Once the geospatial notification is generated, the geospatial notification manager is further configured to notify one or more users 414 via a notification service 412, which is further described below in the method 500.

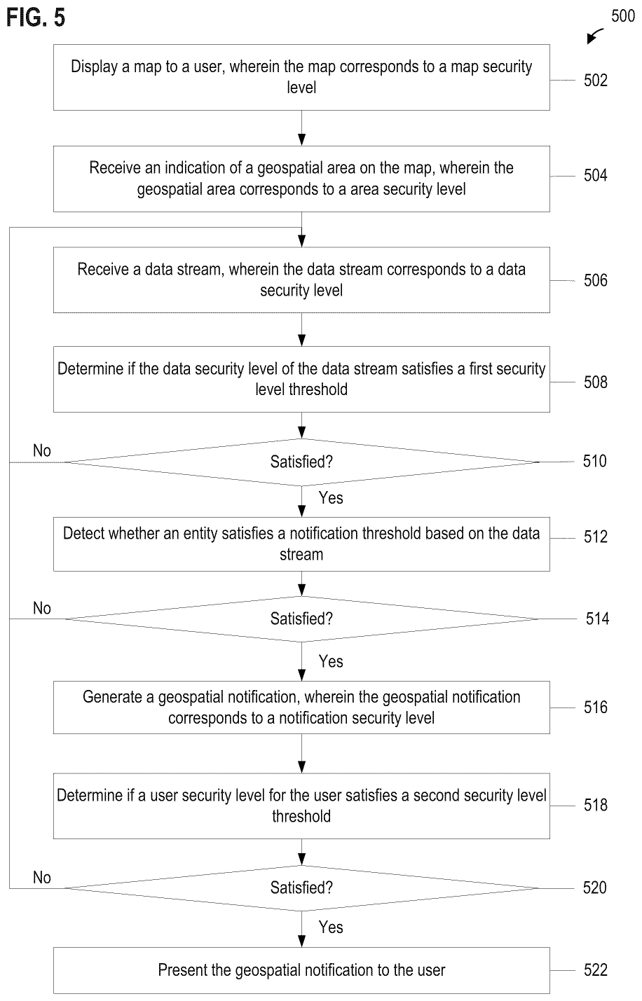

FIG. 5 is a simplified diagram showing a method for providing a security level- based geospatial notification to a user according to one embodiment of the present invention. This diagram is merely an example, which should not unduly limit the scope of the claims. One of ordinary skill in the art would recognize many variations, alternatives, and modifications. The method 500 includes processes 502-522 that are performed using one or more processors. Although the above has been shown using a selected group of processes for the method, there can be many alternatives, modifications, and variations. For example, some of the processes may be expanded and/or combined. Other processes may be inserted to those noted above. Depending upon the embodiment, the sequence of processes may be interchanged with others replaced.

In some embodiments, some or all processes (e.g., steps) of the method 500 are performed by a geospatial notification manager (e.g., 400) executed on a computing system (e.g., 200). In certain examples, some or all processes (e.g., steps) of the method 500 are performed by a computer and/or a processor directed by a code. For example, a computer includes a server computer (e.g., a correlation server/service) and/or a client computer (e.g., a personal computer). In some examples, some or all processes (e.g., steps) of the method 500 are performed according to instructions included by a non-transitory computer-readable medium (e.g., in a computer program product, such as a computer-readable flash drive). For example, a non-transitory computer-readable medium is readable by a computer including a server computer and/or a client computer (e.g., a personal computer, and/or a server rack). As an example, instructions included by a non-transitory computer-readable medium are executed by a processor including a processor of a server computer and/or a processor of a client computer (e.g., a personal computer, and/or server rack).

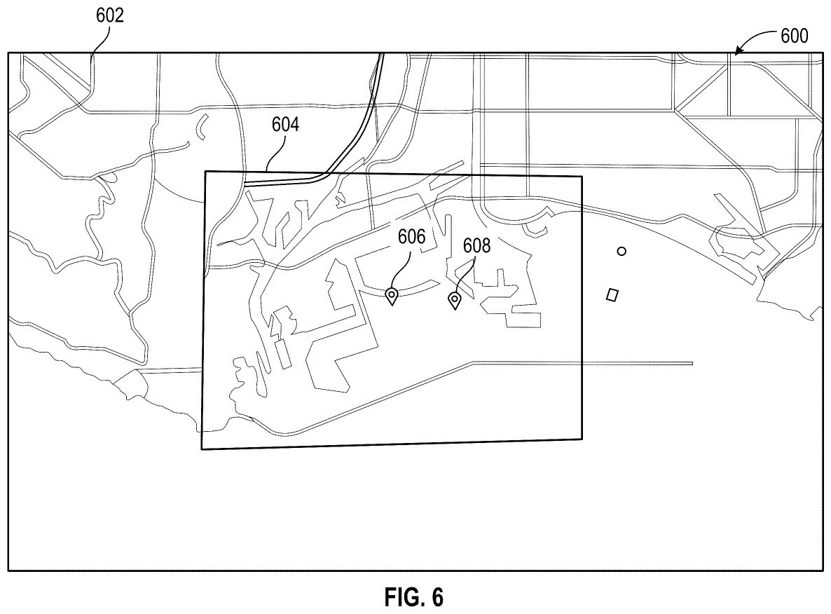

At the process 502, in some embodiments, a map is displayed to a user, and the map corresponds to a map security level. The map security level of the map indicates how much information is shown on the map. For example, the information may include information regarding one or more entities, including article, subject, object, person, being, creature, building, structure, and/or any existence that is detectable. According to some embodiments, the user chooses a region to be displayed on a display screen of a computing system (e.g., 200). For example, FIG. 6 shows an exemplary display screen 600 configured to display a map 602 to a user of the computing system 200. According to certain embodiments, the map security level is based on a user security level of the user. For example, if the user security level is level 3, the map security level of the map displayed to the user is also level 3. In some embodiments, the map includes an option for the user to change the map security level of the map. For example, if the user security level is level 3, the user may choose to display a map with a map security level of 1, 2, or 3. However, the level 3 user will not be able to display the map with the map security level higher than level 3.

At the process 504, in certain embodiments, an indication of a geospatial area is received on the map, and the geospatial area corresponding to an area security level. According to some embodiments, the user may draw any shape of a polygon to indicate a desired geospatial area that the user is interested in. For example, the user input may be received via an interactive element on a display of the computing system 200. For example, in some embodiments, the interactive element is a button, a drawing tool, or any interface element capable of receiving the user input.

According to certain embodiments, the user may select a desired geospatial area from a list of predefined geospatial areas. For example, as shown in the exemplary display screen 600, the geospatial area is presented by a polygon 604. According to some embodiments, the area security level is equal to the map security level. The area security level of the geospatial area indicates how much information that was received within the geospatial area should be accessible to a user. For example, as described further below, the area security level relates to whether data received from sensors that are detected within the geospatial area should be processed. According to some embodiments, the area security level of the geospatial area is set to the same security level as the map security level of the map as default. However, the user may change the area security level of the geospatial area to be lower than the map security level of the map. For example, if the map security level is level 3, the area security level of the geospatial area may be automatically set to level 3. As described above, the user may change the area security level to be lower than level 3 (e.g., level 1 or 2) but not higher than level 3.

At the process 506, in some embodiments, the geospatial notification manager receives a data stream, and the data stream corresponds to a data security level. For example, the data stream represents a location of an entity as a function of time. For example, in some embodiments, the data stream includes video data, image data, satellite imagery data, radar data, sonar data, radio signal data, GPS data, or any other sensor data generated by a sensor. For example, in some embodiments, the sensor is a camera, video, satellite, GPS receiver, radar, sonar, radio sensor, infrared sensor, thermal sensor, LIDAR, or any sensor that generates sensor data that may be used to extract data related to an entity. The data security level of the data stream indicates which users are allowed to access the data stream. For example, if the user security level is level 3, the level 3 user is allowed to access data streams for which the data security level is at or lower than level 3. According to some embodiments, the data security level of an incoming data stream is predetermined or predefined based on where the incoming data stream is received from. For example, a predefined data security level may be associated with each sensor or each type of sensor that is capable of generating a data stream.

At the process 508, in certain embodiments, the geospatial notification manager determines if the data security level of the data stream satisfies a first security level threshold. According to some embodiments, the first security level threshold is the area security level. In other words, the geospatial notification manager determines if the data security level of the data stream is lower than the area security level. As described above, in some embodiments, the area security level corresponds to the geospatial area. In other words, the geospatial notification manager determines if the incoming data steam should be further processed based on the data security level of the data stream and the area security level of the geospatial area.

If the data security level does not satisfy the first security level threshold at the process 510, in some embodiments, the method 500 loops back to the process 506 to continue receiving a next data stream. For example, if an incoming data stream has a data security level of 4 and an area security level of a selected geospatial area is level 3, the data security level of the data stream does not satisfy the first security level threshold. The geospatial notification manager determines that the incoming data stream should not be further processed, and the method 500 loops back to the process 506 to continue receiving a next data stream.

If, however, the data security level satisfies the first security level threshold at the process 510, in certain embodiments, the method 500 proceeds to the process 512. In other words, in some embodiments, the data stream with the data security level that satisfies the first security level threshold is processed in near real-time (e.g., as the data stream is being received). For example, if an area security level of a selected geospatial area is level 3, the data security level of the data stream would satisfy the first security level threshold if the data security level is lower than level 3. In such an example, the method 500 proceeds to the process 512.

At the process 512, in certain embodiments, the geospatial notification manager determines whether an entity that satisfies a notification condition is detected based on the data stream. In other words, the data steam is further analyzed to detect whether an entity that satisfies a notification condition is detected. According to some embodiments, the notification condition is satisfied if an entity has changed from being outside of the geospatial area to being inside the geospatial area. For example, to do so, a polygon match between locations of one or more entities and the geospatial area is performed to determine whether any of the one or more entities has changed from being outside of the geospatial to being inside the geospatial.

If the entity that satisfies the notification condition is not detected in the data stream at the process 514, in some embodiments, the method 500 loops back to the process 506 to continue receiving a next data stream. If, however, the entity that satisfies the notification condition is detected at the process 514, the method 500 proceeds to the process 516.

At the process 516, in some embodiments, the geospatial notification manager generates a geospatial notification that corresponds to a notification security level. According to certain embodiments, the geospatial notification includes information representing the geospatial area and a location of the identified entity that satisfied the notification condition within the geospatial area. In some embodiments, the geospatial notification further includes an identity of the entity and the time when the entity satisfied the notification condition. For example, as shown in the exemplary display screen 600, the geospatial notification may be presented with a geospatial area polygon 604 and the location of the identified entities 606 and 608.

According to some embodiments, the geospatial notification manager generates multiple geospatial notifications based on different thresholds. For example, a first geospatial notification may indicate that the entity is traveling into the geospatial area, a second geospatial notification may indicate that the entity is exiting out of the geospatial area, and/or a third geospatial notification may indicate that one or more entities satisfy a predefined condition. For example, in an example of airplanes, a first geospatial notification may be generated when an airplane is detected within the geospatial area and is heading into the geospatial area. A second geospatial notification may be generated when an airplane is detected within the geospatial area and is heading outside of the geospatial area. A third geospatial notification may be generated when there are more than 3 airplanes within the geospatial area at a given time and/or an airplane with a particular flag is detected within the geospatial area.

According to certain embodiments, a user may request the geospatial notification manager to notify the user if one or more entities satisfy a predefined condition. For example, if a building has four security cameras facing each side, a user may request to be notified if there are more than 100 AI detection of a person within a particular area around the building during a predefined time frame.

According to some embodiments, the predefined condition is a status change (e.g., matching to non-matching state or vice versa).

It should be appreciated that, according to certain embodiments, the geospatial area may be a predefined distance area of a moving entity. For example, a user may request to receive a geospatial notification if an airplane comes near a particular airplane within a certain distance.

According to certain embodiments, the geospatial notification manager may utilize machine learning models (e.g., a language model, a large language model (LLM)) to determine and/or generate a predefined condition for generating or triggering geospatial notifications that the user may be interested in. To do so, the geospatial notification manager may consider previous notification requests and/or previous geospatial notifications.

According to some embodiments, the notification security level of the geospatial notification is set to the same level as the area security level of the geospatial area. For example, if the area security level of the geospatial area is level 3, the notification security level of the geospatial notification is set to level 3. According to certain embodiments, the content of the geospatial notification may depend on the notification security level of the geospatial notification. Additionally or alternatively, in some embodiments, the content included in the geospatial notification may depend on the user security level of the user. In other words, some users may be entitled to more information related to the detected entity compared to other users based on their user security levels.

Subsequently, in certain embodiments, at the process 518, the geospatial notification manager determines if a user security level for the user satisfies a second security level threshold. For example, the second security level threshold is the notification security level of the geospatial notification. In other words, the geospatial notification manager determines if the user security level for the user is higher than or equal to the notification security level of the geospatial notification.

In some embodiments, if the user security level satisfies the second security level threshold, the method 500 proceeds to the process 522 to present the geospatial notification to the user. For example, in some embodiments, if the notification security level of the geospatial notification is set to level 3, the user with the user security level higher than or equal to level 3 is presented with the geospatial notification including the geospatial area, the location of the identified entity that satisfied the notification condition within the geospatial area, the identity of the entity, and the time when the entity satisfied the notification condition.

If, however, the user security level does not satisfy the second security level threshold, the method 500 loops back to the process 506 to continue receiving a next data stream. For example, if the user has the user security level lower than the notification security level of the geospatial notification, the user is not notified. However, according to some embodiments, if the user security level does not satisfy the second security level threshold, the geospatial notification manager edits (e.g., restricts, redacts, etc.) the content of the geospatial notification based on the user security level and the edited geospatial notification is presented to the user. For example, if the notification security level of the geospatial notification is set to level 3, the user with the user security level lower than level 3 is presented with a geospatial notification with limited information. If the user security level is level 2, the geospatial notification may include information about the geospatial area and the time when the entity that satisfied the notification condition is detected within the geospatial area. If the user security level is level 1, the geospatial notification may include the geospatial area and the fact that an entity has been detected during a past predetermined time period (e.g., last 24 hours). If the user security level is level 0, the user will not receive a notification.

According to some embodiments, the geospatial notification is further stored in a database. For example, this allows authorized users to view a history of geospatial notifications of events that occurred within the geospatial area.

According to some embodiments, additional users may also be presented with the geospatial notification based on the user security level of the corresponding additional users. The geospatial notification with the notification security level of level 3 may be presented to users with higher user security level (e.g., user security level 4 and 5). In other words, the geospatial notification manager controls who are notified of a triggered event that occurred within a geospatial area.

According to certain embodiments, a first user who received the geospatial notification can send the geospatial notification to a second user. However, it should be appreciated that the second user must satisfy the second security level threshold in order to view the geospatial notification. As described above, the content of the geospatial notification may be edited or limited based on the user security level of the second user.

FIG. 6 illustrates an exemplary screenshot of a display screen for displaying a geospatial notification on a map in accordance with at least one example set forth in the disclosure. This screenshot is merely an example. One of ordinary skill in the art would recognize many variations, alternatives, and modifications.

As shown in FIG. 6, the exemplary display screen 600 displays a map 602 to a user of the computing system 200 with a geospatial area indicator 604 and locations at which entities (e.g., 606, 608) satisfied a notification condition. In some embodiments, the entity is an article, subject, object, person, being, creature, building, structure, any existence that is detectable, and/or the like. For example, the exemplary display screen 600 is an example of a geospatial notification that is presented to the user indicating locations of entities 606, 608 that satisfied a notification condition within the identified geospatial area 604 during a predefined time period (e.g., in the last 24 hours). Although it is not shown on the map 602, the geospatial notification may further include the exact time when the entities 606, 608 satisfied the notification condition.

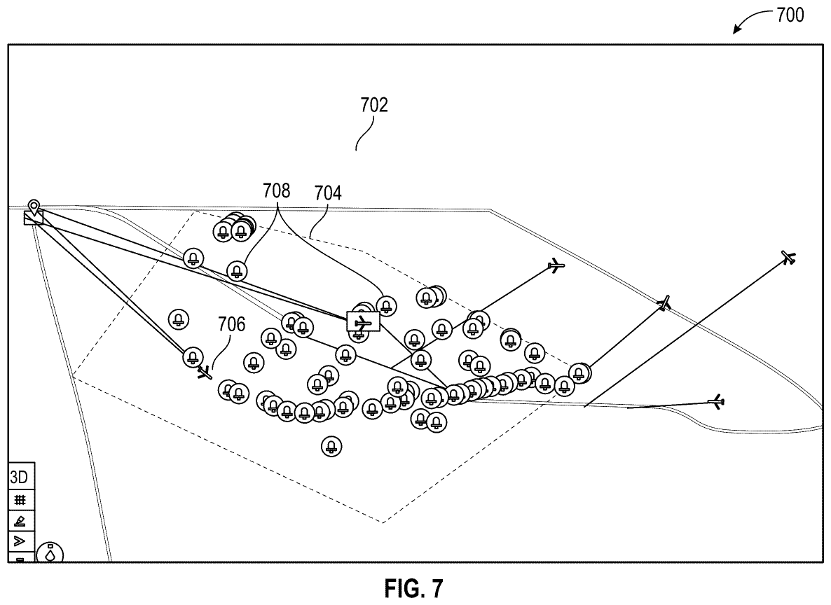

FIG. 7 illustrates an exemplary screenshot of a display screen for displaying a geospatial notification on a map in accordance with at least one example set forth in the disclosure. This screenshot is merely an example. One of ordinary skill in the art would recognize many variations, alternatives, and modifications.

As shown in FIG. 7, the exemplary display screen 700 displays a map 702 to a user of the computing system 200 with a geospatial area indicator 704 and locations at which entities 706 satisfied a notification condition. In some embodiments, the entity is an article, subject, object, person, being, creature, building, structure, any existence that is detectable, and/or the like. As an example, the entities 706 are airplanes. For example, the exemplary display screen 700 is an example of a geospatial notification that is presented to the user indicating locations of entities 706 that satisfied a notification condition within the identified geospatial area 704 during a predefined time period (e.g., in the last 24 hours). Although it is not shown on the map 702, the geospatial notification may further include the exact time when the entities 706 were detected at the indicated locations within the geospatial area 704.

According to certain embodiments, a method for providing a security level based geospatial notification, the method comprising: displaying a map to a user, the map corresponding to a map security level, receiving an indication of a geospatial area on the map, the geospatial area corresponding to an area security level, receiving a data stream, the data stream corresponds to a data security level, determining if the data security level satisfies a first security level threshold, in response to determining that the data security level satisfies the first security level threshold, detecting whether an entity satisfies a notification condition based on the data stream, in response to detecting the entity that satisfies the notification condition, generating a geospatial notification including information representing the geospatial area and the entity, determining if a user security level for the user satisfies a second security level threshold, and in response to determining that the user security level satisfies the second security level threshold, presenting the geospatial notification to the user, wherein the method is performed using one or more processors. For example, the method is implemented according to at least FIG. 4 and/or FIG. 5.

In some embodiments, the method further comprises in response to determining that the user security level does not satisfy the second security level threshold, editing content of the geospatial notification based on the user security level, and presenting the edited geospatial notification to the user. In some embodiments, the area security level is equal to the map security level. In some embodiments, the geospatial notification includes an identity of the entity and the time when the entity satisfied the notification condition.

In some embodiments, wherein determining if the data security level satisfies a first security level threshold comprises determining if the data security level is lower than the area security level. In some embodiments, wherein determining whether the entity has satisfied the notification condition based on the data stream comprises determining whether the entity has changed from being outside of the geospatial area to being inside the geospatial area based on the data stream.

In some embodiments, the geospatial notification includes an identity of the entity and the time when the entity has changed from being outside of the geospatial area to being inside the geospatial area based on the data stream. In some embodiments, the geospatial notification corresponds to a notification security level.

In some embodiments, wherein determining if the user security level for the user satisfies the second security level threshold comprises determining if the user security level is higher than or equal to the notification security level. In some embodiments, wherein in response to determining that the user security level does not satisfy the second security level threshold, presenting a portion of the geospatial notification to the user based on the user security level.

In some embodiments, wherein presenting the geospatial notification to the user comprises displaying the geospatial notification on a user interface. In some embodiments, wherein presenting the geospatial notification to the user comprises sending to the user a message about the geospatial notification. In some embodiments, wherein receiving the data stream comprises receiving the data stream in near real-time. In some embodiments, the notification condition is defined by the user. In some embodiments, the notification condition is defined by one or more machine learning models.

In some embodiments, the method further comprises transmitting the geospatial notification to a second user based on a user security level of the second user. In some embodiments, wherein generating the geospatial notification includes at least one selected from a group consisting of generating a first geospatial notification indicating that the entity goes into the geospatial area, generating a second geospatial notification indicating that the entity goes out of the geospatial area, and generating a third geospatial notification indicating that one or more entities satisfy one or more criteria. In some embodiments, the one or more criteria are defined by the user. In some embodiments, the one or more criteria are defined by one or more machine learning models.

According to certain embodiments, a computing device for providing a security level based geospatial notification comprises a processor and a memory having a plurality of instructions stored thereon that, when executed by the processor, causes the computing device to display a map to a user, the map corresponding to a map security level, receive an indication of a geospatial area on the map, the geospatial area corresponding to an area security level, receive a data stream, the data stream corresponds to a data security level, determine if the data security level satisfies a first security level threshold, in response to the determination that the data security level satisfies the first security level threshold, detect whether an entity satisfies a notification condition based on the data stream, in response to the detection of the entity that satisfies the notification condition, generate a geospatial notification including information representing the geospatial area and the entity, determine if a user security level for the user satisfies a second security level threshold, and in response to the determination that the user security level satisfies the second security level threshold, present the geospatial notification to the user.

In some embodiments, the plurality of instructions, when executed, further cause the computing device to: in response to the determination that the user security level does not satisfy the second security level threshold, edit content of the geospatial notification based on the user security level, and present the edited geospatial notification to the user. In some embodiments, the area security level is equal to the map security level. In some embodiments, the geospatial notification includes an identity of the entity and the time when the entity satisfied the notification condition.

In some embodiments, wherein to determine if the data security level satisfies a first security level threshold comprises to determine if the data security level is lower than the area security level. In some embodiments, wherein to determine whether the entity has satisfied the notification condition based on the data stream comprises to determine whether the entity has changed from being outside of the geospatial area to being inside the geospatial area based on the data stream.

In some embodiments, the geospatial notification includes an identity of the entity and the time when the entity has changed from being outside of the geospatial area to being inside the geospatial area based on the data stream. In some embodiments, the geospatial notification corresponds to a notification security level.

In some embodiments, wherein to determine if the user security level for the user satisfies the second security level threshold comprises to determine if the user security level is higher than or equal to the notification security level. In some embodiments, wherein in response to the determination that the user security level does not satisfy the second security level threshold, present a portion of the geospatial notification to the user based on the user security level.

In some embodiments, wherein to present the geospatial notification to the user comprises to display the geospatial notification on a user interface. In some embodiments, wherein to present the geospatial notification to the user comprises to send to the user a message about the geospatial notification. In some embodiments, wherein to receive the data stream comprises to receive the data stream in near real-time. In some embodiments, the notification condition is defined by the user. In some embodiments, the notification condition is defined by one or more machine learning models.

In some embodiments, the plurality of instructions, when executed, further cause the computing device to: transmit the geospatial notification to a second user based on a user security level of the second user. In some embodiments, wherein to generate the geospatial notification includes at least one selected from a group consisting of to: generate a first geospatial notification indicating that the entity goes into the geospatial area, generate a second geospatial notification indicating that the entity goes out of the geospatial area, and generate a third geospatial notification indicating that one or more entities satisfy one or more criteria. In some embodiments, the one or more criteria are defined by the user. In some embodiments, the one or more criteria are defined by one or more machine learning models.

According to certain embodiments, a non-transitory computer-readable medium storing instructions for providing a security level based geospatial notification, the instructions when executed by one or more processors of a computing device, cause the computing device to display a map to a user, the map corresponding to a map security level, receive an indication of a geospatial area on the map, the geospatial area corresponding to an area security level, receive a data stream, the data stream corresponds to a data security level, determine if the data security level satisfies a first security level threshold, in response to the determination that the data security level satisfies the first security level threshold, detect whether an entity satisfies a notification condition based on the data stream, in response to the detection of the entity that satisfies the notification condition, generate a geospatial notification including information representing the geospatial area and the entity, determine if a user security level for the user satisfies a second security level threshold, and in response to the determination that the user security level satisfies the second security level threshold, present the geospatial notification to the user.

In some embodiments, the instructions when executed by the one or more processors further cause the computing device to: in response to the determination that the user security level does not satisfy the second security level threshold, edit content of the geospatial notification based on the user security level, and present the edited geospatial notification to the user. In some embodiments, the area security level is equal to the map security level. In some embodiments, the geospatial notification includes an identity of the entity and the time when the entity satisfied the notification condition.

In some embodiments, wherein to determine if the data security level satisfies a first security level threshold comprises to determine if the data security level is lower than the area security level. In some embodiments, wherein to determine whether the entity has satisfied the notification condition based on the data stream comprises to determine whether the entity has changed from being outside of the geospatial area to being inside the geospatial area based on the data stream.

In some embodiments, the geospatial notification includes an identity of the entity and the time when the entity has changed from being outside of the geospatial area to being inside the geospatial area based on the data stream. In some embodiments, the geospatial notification corresponds to a notification security level.

In some embodiments, wherein to determine if the user security level for the user satisfies the second security level threshold comprises to determine if the user security level is higher than or equal to the notification security level. In some embodiments, wherein in response to the determination that the user security level does not satisfy the second security level threshold, present a portion of the geospatial notification to the user based on the user security level.

In some embodiments, wherein to present the geospatial notification to the user comprises to display the geospatial notification on a user interface. In some embodiments, wherein to present the geospatial notification to the user comprises to send to the user a message about the geospatial notification. In some embodiments, wherein to receive the data stream comprises to receive the data stream in near real-time. In some embodiments, the notification condition is defined by the user. In some embodiments, the notification condition is defined by one or more machine learning models.

In some embodiments, the instructions when executed by the one or more processors further cause the computing device to: transmit the geospatial notification to a second user based on a user security level of the second user. In some embodiments, wherein to generate the geospatial notification includes at least one selected from a group consisting of to: generate a first geospatial notification indicating that the entity goes into the geospatial area, generate a second geospatial notification indicating that the entity goes out of the geospatial area, and generate a third geospatial notification indicating that one or more entities satisfy one or more criteria. In some embodiments, the one or more criteria are defined by the user. In some embodiments, the one or more criteria are defined by one or more machine learning models.

For example, some or all components of various embodiments of the present disclosure each are, individually and/or in combination with at least another component, implemented using one or more software components, one or more hardware components, and/or one or more combinations of software and hardware components. In another example, some or all components of various embodiments of the present disclosure each are, individually and/or in combination with at least another component, implemented in one or more circuits, such as one or more analog circuits and/or one or more digital circuits. In yet another example, while the embodiments described above refer to particular features, the scope of the present disclosure also includes embodiments having different combinations of features and embodiments that do not include all of the described features. In yet another example, various embodiments and/or examples of the present disclosure can be combined.

Additionally, the methods and systems described herein may be implemented on many different types of processing devices by program code comprising program instructions that are executable by the device processing subsystem. The software program instructions may include source code, object code, machine code, or any other stored data that is operable to cause a processing system (e.g., one or more components of the processing system) to perform the methods and operations described herein. Other implementations may also be used, however, such as firmware or even appropriately designed hardware configured to perform the methods and systems described herein.

The systems' and methods' data (e.g., associations, mappings, data input, data output, intermediate data results, final data results, etc.) may be stored and implemented in one or more different types of computer-implemented data stores, such as different types of storage devices and programming constructs (e.g., RAM, ROM, EEPROM, Flash memory, flat files, databases, programming data structures, programming variables, IF-THEN (or similar type) statement constructs, application programming interface, etc.). It is noted that data structures describe formats for use in organizing and storing data in databases, programs, memory, or other computer-readable media for use by a computer program.

The systems and methods may be provided on many different types of computer-readable media including computer storage mechanisms (e.g., CD-ROM, diskette, RAM, flash memory, computer's hard drive, DVD, etc.) that contain instructions (e.g., software) for use in execution by a processor to perform the methods' operations and implement the systems described herein. The computer components, software modules, functions, data stores and data structures described herein may be connected directly or indirectly to each other in order to allow the flow of data needed for their operations. It is also noted that a module or processor includes a unit of code that performs a software operation and can be implemented, for example, as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

The computing system can include client devices and servers. A client device and server are generally remote from each other and typically interact through a communication network. The relationship of client device and server arises by virtue of computer programs running on the respective computers and having a client device-server relationship to each other.

This specification contains many specifics for particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations, one or more features from a combination can in some cases be removed from the combination, and a combination may, for example, be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Although specific embodiments of the present disclosure have been described, it will be understood by those of skill in the art that there are other embodiments that are equivalent to the described embodiments. Accordingly, it is to be understood that the invention is not to be limited by the specific illustrated embodiments. Various modifications and alterations of the disclosed embodiments will be apparent to those skilled in the art. The embodiments described herein are illustrative examples. The features of one disclosed example can also be applied to all other disclosed examples unless otherwise indicated. It should also be understood that all U.S. patents, patent application publications, and other patent and non-patent documents referred to herein are incorporated by reference, to the extent they do not contradict the foregoing disclosure.

What is claimed is:

1. A method for providing a security level based geospatial notification, the method comprising:
displaying a map to a user, the map corresponding to a map security level;
receiving an indication of a geospatial area on the map, the geospatial area corresponding to an area security level;
receiving a data stream, the data stream corresponds to a data security level:
determining if the data security level satisfies a first security level threshold;
in response to determining that the data security level satisfies the first security level threshold, detecting whether an entity satisfies a notification condition based on the data stream;
in response to detecting the entity that satisfies the notification condition, generating a geospatial notification including information representing the geospatial area and the entity;
determining if a user security level for the user satisfies a second security level threshold; and
in response to determining that the user security level satisfies the second security level threshold, presenting the geospatial notification to the user;
wherein the method is performed using one or more processors.

2. The method of claim 1, further comprising:
in response to determining that the user security level does not satisfy the second security level threshold, editing content of the geospatial notification based on the user security level; and
presenting the edited geospatial notification to the user.

3. The method of claim 1, wherein determining if the data security level satisfies a first security level threshold comprises determining if the data security level is lower than the area security level.

4. The method of claim 1, wherein determining whether the entity has satisfied the notification condition based on the data stream comprises determining whether the entity has changed from being outside of the geospatial area to being inside the geospatial area based on the data stream.

5. The method of claim 4, wherein the geospatial notification includes an identity of the entity and the time when the entity has changed from being outside of the geospatial area to being inside the geospatial area based on the data stream.

6. The method of claim 5, wherein determining if the user security level for the user satisfies the second security level threshold comprises determining if the user security level is higher than or equal to the notification security level.

7. The method of claim 1, wherein in response to determining that the user security level does not satisfy the second security level threshold, presenting a portion of the geospatial notification to the user based on the user security level.

8. The method of claim 1, wherein the area security level is equal to the map security level.

9. The method of claim 1, wherein the geospatial notification includes an identity of the entity and the time when the entity satisfied the notification condition.

10. The method of claim 1, wherein the geospatial notification corresponds to a notification security level.

11. The method of claim 1, further comprising:
transmitting the geospatial notification to a second user based on a user security level of the second user.

12. The method of claim 1, wherein generating the geospatial notification includes at least one selected from a group consisting of:
generating a first geospatial notification indicating that the entity goes into the geospatial area;
generating a second geospatial notification indicating that the entity goes out of the geospatial area; and
generating a third geospatial notification indicating that one or more entities satisfy one or more criteria.

13. A computing device for providing a security level based geospatial notification, the computing device comprising:
a processor; and
a memory having a plurality of instructions stored thereon that, when executed by the processor, causes the computing device to:
display a map to a user, the map corresponding to a map security level;
receive an indication of a geospatial area on the map, the geospatial area corresponding to an area security level;
receive a data stream, the data stream corresponds to a data security level;
determine if the data security level satisfies a first security level threshold;
in response to the determination that the data security level satisfies the first security level threshold, detect whether an entity satisfies a notification condition based on the data stream;
in response to the detection of the entity that satisfies the notification condition, generate a geospatial notification including information representing the geospatial area and the entity;
determine if a user security level for the user satisfies a second security level threshold; and
in response to the determination that the user security level satisfies the second security level threshold, present the geospatial notification to the user.

14. The computing device of claim 13, wherein the plurality of instructions, when executed, further cause the computing device to:
in response to the determination that the user security level does not satisfy the second security level threshold, edit content of the geospatial notification based on the user security level; and
present the edited geospatial notification to the user.

15. The computing device of claim 13, wherein to determine if the data security level satisfies a first security level threshold comprises to determine if the data security level is lower than the area security level.

16. The computing device of claim 13, wherein to determine whether the entity has satisfied the notification condition based on the data stream comprises to determine whether the entity has changed from being outside of the geospatial area to being inside the geospatial area based on the data stream, wherein the geospatial notification includes an identity of the entity and the time when the entity has changed from being outside of the geospatial area to being inside the geospatial area based on the data stream.

17. A non-transitory computer-readable medium storing instructions for providing a security level based geospatial notification, the instructions when executed by one or more processors of a computing device, cause the computing device to:
display a map to a user, the map corresponding to a map security level:
receive an indication of a geospatial area on the map, the geospatial area corresponding to an area security level;
receive a data stream, the data stream corresponds to a data security level;
determine if the data security level satisfies a first security level threshold;
in response to the determination that the data security level satisfies the first security level threshold, detect whether an entity satisfies a notification condition based on the data stream;
in response to the detection of the entity that satisfies the notification condition, generate a geospatial notification including information representing the geospatial area and the entity;
determine if a user security level for the user satisfies a second security level threshold; and
in response to the determination that the user security level satisfies the second security level threshold, present the geospatial notification to the user.

18. The non-transitory computer-readable medium of claim 17, wherein the instructions when executed by the one or more processors further cause the computing device to:
in response to the determination that the user security level does not satisfy the second security level threshold, edit content of the geospatial notification based on the user security level; and
present the edited geospatial notification to the user.

19. The non-transitory computer-readable medium of claim 17, wherein to determine if the data security level satisfies a first security level threshold comprises to determine if the data security level is lower than the area security level.

20. The non-transitory computer-readable medium of claim 17, wherein to determine whether the entity has satisfied the notification condition based on the data stream comprises to determine whether the entity has changed from being outside of the geospatial area to being inside the geospatial area based on the data stream, wherein the geospatial notification includes an identity of the entity and the time when the entity has changed from being outside of the geospatial area to being inside the geospatial area based on the data stream.
